(19) United States
(12) Patent Application Publication
(10) Pub. No.: US 2005/0251649 A1
(43) Pub. Date: Nov. 10, 2005

(54) Methods and apparatus for address map optimization on a multi-scalar extension

(75) Inventor: Takeshi Yamazaki, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Computer Entertainment Inc., Tokyo (JP)

(21) Appl. No.: 11/110,492

(22) Filed: Apr. 20, 2005

Related U.S. Application Data
(60) Provisional application No. 60/564,843, filed on Apr. 23, 2004.

(51) Int. Cl. G06F 15/00

(52) U.S. Cl. 712/20

(57) ABSTRACT

Methods and systems are disclosed for staggered address mapping of memory regions in shared memory for use in multi-threaded processing of single instruction multiple data (SIMD) threads and multi-scalar threads without inter-thread memory region conflicts and permitting transition from SIMD mode to multi-scalar mode without the need for rearrangement of data stored in the memory regions.

### CROSS REFERENCE TO RELATED APPLICATIONS

This application claims the benefit of the filing date of U.S. Provisional Patent Application No. 60/564,843 filed Apr. 23, 2004, the disclosure of which is hereby incorporated herein by reference.

### BACKGROUND OF THE INVENTION

The present application relates to the organization and operation of processors and more particularly relates to allocation of memory in a processor having a plurality of execution units capable of independently executing multiple instruction threads.

In computations related to graphic rendering, modeling, or numerical analysis, for example, it is frequently advantageous to process multiple instruction threads simultaneously. In certain situations, such as those related to, for example, modeling physical phenomena or building graphical worlds, it may be advantageous to process threads in which the same instructions are executed as to different data sets. This can take the form of a plurality of execution units performing SIMD (“single instruction multiple data”) execution on large chunks of data or on independent pieces of data that are divided among execution units for processing (for numerical analysis or modeling, for example). Alternatively, it is sometimes advantageous to execute different process threads independently by different execution units of a processor, particularly when the threads include different instructions. Such method of execution is known as multi-scalar. In multi-scalar execution, the data handled by each execution unit is manipulated independently from the way data is manipulated by any other execution unit.

Commonly assigned, co-pending U.S. patent application Ser. No. 09/815,554 filed Mar. 22, 2001 describes a processing environment which is background to the invention but which is not admitted to be prior art. This application is hereby incorporated by reference herein. As described therein, each processor unit (PU) includes a plurality of attached processor units (APUs) that utilize separately allocated portions of a common memory for storage of instructions and data used while executing instructions. Each APU, in turn, includes a local memory and a plurality of functional units used to execute instructions, each functional unit including a floating point unit and an integer unit.

However, current parallel processing systems require loading and storing of multiple pieces of data for execution of multiple instruction threads. In particular, the multiple data values are typically stored in parallel locations within the same shared address space. This can lead to conflicts and delays when multiple data values are requested from the same memory pipeline, and may require that execution of the multiple threads be delayed in its entirety until all values have been received from the shared memory.

### SUMMARY OF THE INVENTION

The present invention solves these problems and others by providing a system and method for address map optimization in a multi-threaded processing environment such as on a multi-scalar extension of a processor that supports SIMD processing.

In one aspect of the invention, a system is provided for optimizing address maps for multiple data values employed during parallel execution of instructions on multiple processor threads. Preferably, such system reduces memory conflict and thread delay due to the use of shared memory.

In another aspect of the invention, a method for staggered allocation of address maps is provided that distributes multiple data values employed during parallel execution of instructions on multiple processor threads in order to evenly distribute processor and memory load among multiple functional units and multiple local stores of a synergistic processing unit and/or a processing unit.

In another aspect of the invention, a method for staggered allocation of address maps is provided that permits easy transition from a single instruction multiple data processing mode to a multi-scalar processing mode without requiring substantial rearrangement of data in memory.

According to another aspect of the invention, a method is provided for executing instructions by a plurality n of functional units of a processor, the n functional units operable to execute instructions in a single instruction multiple data (SIMD) manner and to execute instructions in a multi-scalar manner.

According to a preferred aspect of the invention, such method includes loading data from a shared memory into one or more registers, each register holding data for execution by a particular functional unit of the plurality of functional units. Then, an operation is performed selected from the group consisting of: executing an instruction by the plurality n of functional units on data held in the registers belonging to all of the plurality n of functional units; and executing one or more instructions by a number x, 0<x<n, of functional units on the data loaded in a corresponding number x of the registers belonging to the x functional units. Thereafter, second data held in respective ones of the registers is stored to locations of the shared memory in respective regions of the shared memory, the locations further being vertically offset from each other.

### DESCRIPTION OF THE DRAWINGS

For the purposes of illustration, there are forms shown in the drawings that are presently preferred, it being understood, however, that the invention is not limited to the precise arrangements and instrumentalities shown.

FIG. 1 is a system diagram illustrating a multi-threaded processing environment according to an embodiment of the invention;

FIG. 2 is a system diagram illustrating a synergistic processing unit according to an embodiment of the invention;

FIG. 3 is a functional diagram illustrating a par slot multi-bank memory allocation method according to an embodiment of the invention;

FIG. 4 is a functional diagram illustrating a thread data set allocation method according to an embodiment of the invention;

FIG. 5 is a functional diagram illustrating a par block multi-bank memory allocation method according to an embodiment of the invention; and,

FIG. 6 is a functional diagram illustrating a staggered memory allocation method according to an embodiment of the invention.

### DETAILED DESCRIPTION

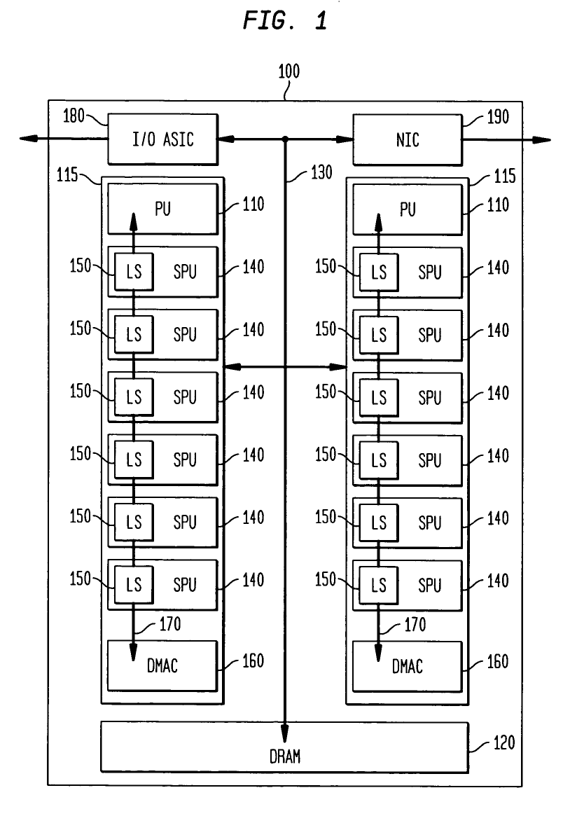

With reference to the drawings, where like numerals indicate like elements, there is shown in FIG. 1 a multi-processing system 100 in accordance with one or more aspects of the present invention. The multi-processing system 100 includes a plurality of processing units 110 (any number may be used) coupled to a shared memory 120, such as a DRAM, over a system bus 130. It is noted that the shared memory 120 need not be a DRAM; indeed, it may be formed using any known or hereinafter developed technology. Each processing unit 110 is advantageously associated with one or more synergistic processing units (SPUs) 140. The SPUs 140 are each associated with at least one local store (LS) 150, which, through a direct memory access channel (DMAC) 160, have access to an defined region of the shared memory 120. Each PU 110 communicates with its subcomponents through a PU bus 170. The multi-processing system 100 advantageously communicates locally with other multi-processing systems or computer components through a local I/O ASIC channel 180, although other communications standards and channels may be employed. Network communication is performed by one or more network interface cards (NIC) 190, which may, for example, include Ethernet, Infiniband™ (a mark of the Infiniband Trade Association®), wireless, or other currently existing or later developed networking technology. The NICs 190 may be provided at the multi-processing system 100 or may be associated with one or more of the individual processing units 110 or SPUs 140.

Incoming instructions are handled by a particular PU 110, and are distributed among one or more of the SPUs 140 for execution through use of the LSs 150 and shared memory 120. The units formed by each PU 110 and the SPUs 140 can be referred to as “broadband engines” (BEs) 115.

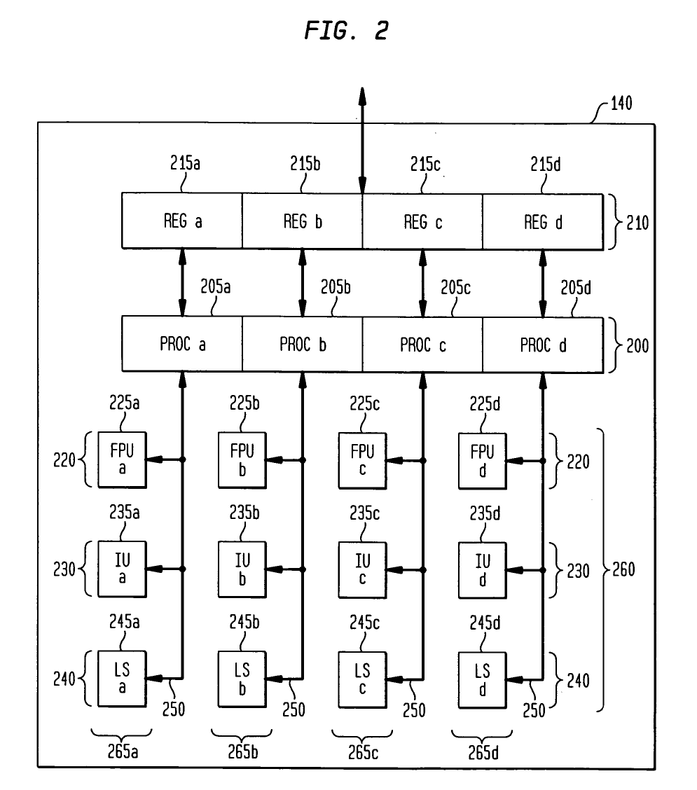

FIG. 2 is a system diagram illustrating an organization of a synergistic processing unit according to an embodiment of the invention. The SPU 140 includes an instruction processing element (PROC) 200 and a local storage register (REG) 210. The PROC 200 and the REG 210 process multiple threads, i.e. multiple sequences of instructions. Thus, when four threads are being processed, the instruction processing element 200 converts instructions to operations performed by each of the functional units 265a, 265b, 265c, and 265d. The register 210 forms effective subregisters 215a, 215b, 215c and 215d at such time. When single instruction multiple data (SIMD) execution is performed, the functional units 265a-265d each execute the same instruction, but on different data, the data held in registers 215a, 215b, 215c, and 215d.

To execute instructions, the SPU 140 further includes a set of floating point units (FPUs) 220 to perform floating point operations, and a set of integer units (IUs) 230 to perform integer operations. A set of local stores (LS) is provided for access to shared memory 120 (FIG. 1) by the SPU 140. Each FPU 220 and IU 230 of the SPU 140 together form a “functional unit” 260 such that an SPU 140 having four functional units 265a, 265b, 265c and 265d is capable of handling up to four threads when executing multiple threads. In such case, each functional unit 265a, 265b, 265c and 265d includes a respective FPU 225a, 225b, 225c and 225d, IU 235a, 235b, 235c and 235d, and each functional unit accesses a local store LS 245a, 245b, 245c and 245d. Each functional unit 260 employs a FU bus 250 electrically coupling the respective FU 260 to the processing element 200. Typically, an SPU 140 can only multi-thread as many separate threads as there are functional units 260 in the SPU 140.

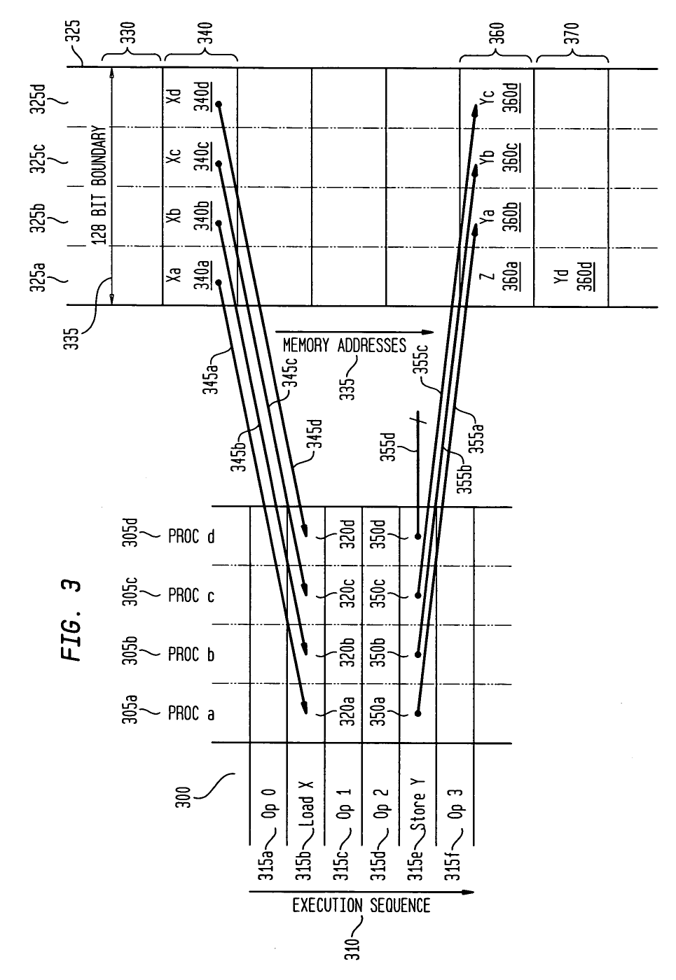

FIG. 3 is a functional diagram illustrating par slot multi-bank memory allocation in a single instruction multiple data (SIMD) execution environment. A functional SPU representation 300 includes, in this embodiment, functional units 305a, 305b, 305c and 305d each executing the same execution sequence 310 of instructions 315a, 315b, 315c, 315d, 315e and 315f. The intersection of instructions 315a-315f and functional units 305a-306d in a chart form represents the registers operated upon by the instructions 315a-315f.

Similarly, memory 325 is organized as four local stores 325a, 325b, 325c and 325d, one local store utilized by each functional unit, e.g., functional unit 305a, such that any particular row of memory 330 across the four local stores 325a-325d would, in this embodiment, form a 128 bit boundary 335 for processing four 32 bit values stored therein. Thus, at instruction 315b the value X is loaded. Different boundaries 335 and value sizes, as well as a different number of threads, may be used.

In memory 325, the 128 bit memory row 340 includes four data values: Xa (340a) stored in LSa (325a) at row 340, Xb (340b) stored in LSb (325b) at row 340, Xc (340c) stored in LSc (325c) at row 340, and Xd (340d) stored in LSd at row 340. Each 32 bit value is loaded 345a, 345b, 345c and 345d from its respective LS and row location 340a, 340b, 340c and 340d to the process register 320a, 320b, 320c and 320d for processor operations. After additional processor instructions 315c and 315d, instruction 315e attempts to store a value Y from each of the registers 350a, 350b, 350c and 350d of the respective functional units 305a-305d in the shared memory 325 at memory row 360. In this case, however, LSa 325a already has a value Z stored in location 360a.

Thus, when the SPU attempts to take register values 350a, 350b, 350c and 350d and store them 355a, 355b, 355c and 355d at shared memory row 360, it cannot store the full 128-bit row of four 32 bit values Ya 350a, Yb 350b, Yc 350c and Yd, 350d, because the full 128 bits of row 360 are not available due to pre-existing value Z 360a. While the value Yd could be stored at another location 375 of memory row 370, this requires destroying the 128 bit boundaries of multiple data values and processing multiple rows of memory 360 and 370 in order to perform a single parallel load or store operation. Such parallel load or store operation across the 128 bit boundaries requires sequential rather than parallel access. It is much less efficient than loading and storing to a contiguous row at once such as row 340. It is therefore to be avoided.

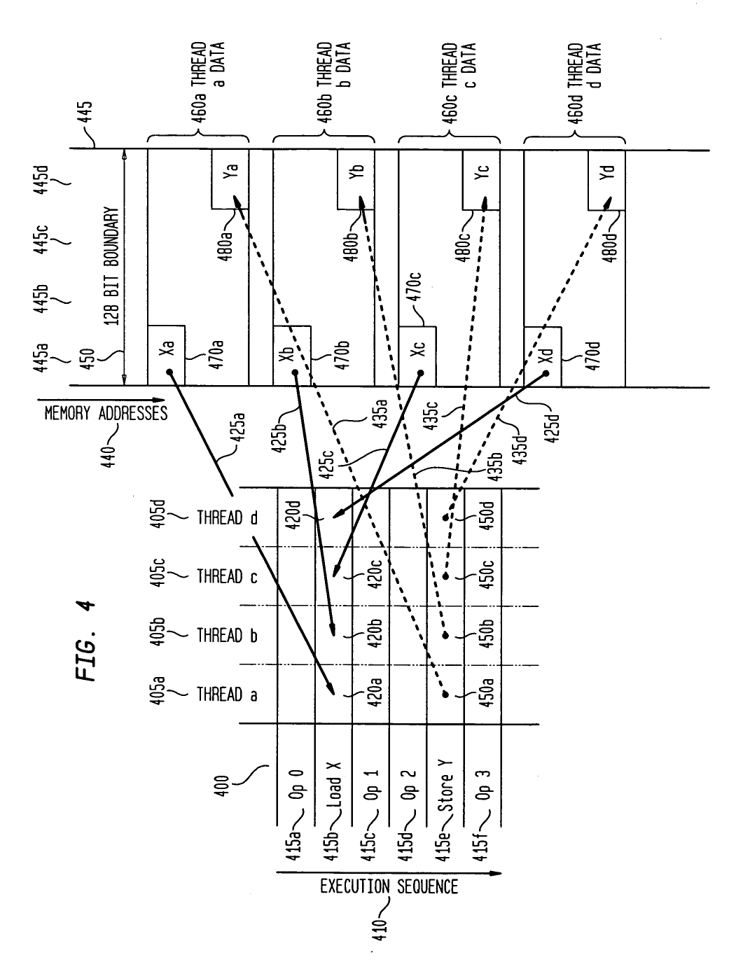

FIG. 4 is a functional diagram illustrating an embodiment of thread data set allocation in single instruction multiple data execution on a multi-threaded processing environment. As previously, a functional SPU representation 400 includes four functional units 405a, 405b, 405c and 405d each performing the same execution sequence 410 of example p rocessor instructions 415a, 415b, 415c, 415d, 415e and 415f. The intersection of instructions 415a-415f and functional units 405a-405d in a chart form represents the registers operated upon by the functional units 405a-405d. As before, at execution instruction 415b, a set of values X is loaded into registers 420a, 420b, 420c and 420d. At execution instruction 415e, a set of values Y is stored from registers 430a, 430b, 430c and 430d into shared memory 445.

A functional shared memory representation 445 is shown with respect to memory addresses 440. Whereas in the previous SIMD memory regime, memory was allocated and accessed with respect to the local stores LSa 445a, LSb 445b, LSc 445c and LSd 445d, in this case functional units 405a, 405b, 405c and 405d directly allocate a direct memory region for storage of respective thread data sets 460a, 460b, 460c and 460d. Each thread data set 460a, 460b, 460c and 460d is aligned at a block boundary size, in this case the 128 bit boundary 450 provided by the four local stores 445a, 445b, 445c and 445d. The block boundary size may be any natural block boundary of the form 2\hat{ }n, although generally the block boundary will be at least 16 bits or greater in size.

Thus, at execution of instruction 415b loading the set of values X into the registers, value Xa 470a is loaded 425a from thread a data set 460a into register 420a, value Xb 470b is loaded 425b from thread b data set 460b into register 420b, value Xc 470c is loaded 425c from thread c data set 460c into register 420c, and value Xd 470d is loaded 425d from thread d data set 460d into register 420d. Similarly, at execution of instruction 415e storing the set of values Y from registers 430a-430d into shared memory 445, the content of register 430a is stored 435a into thread a data set 460a as value Ya 480a, the content of register 430b is stored 435b into thread b data set 460b as value Yb 480b, the content of register 430c is stored 435c into thread c data set 460c as value Yc 480c, and the content of register 430d is stored 435d into thread d data set 460d as value Yd 480d.

In this memory access regime, the location of values is not correlated to particular associated local stores, but is rather correlated to a particular thread data set allocated to a particular functional unit in a multi-scalar processing environment.

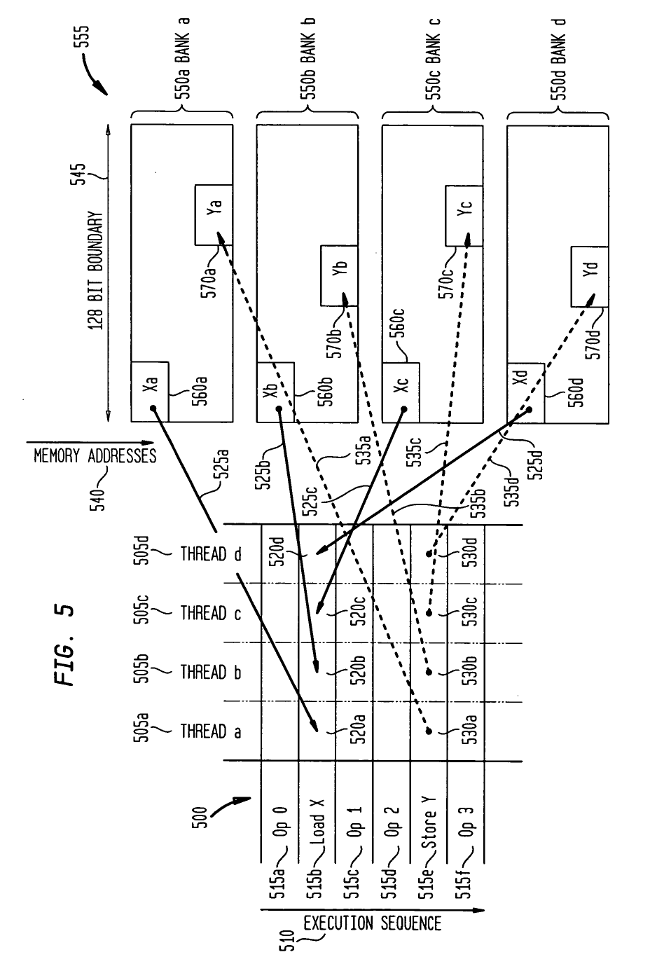

FIG. 5 is a functional diagram illustrating a par block multi-bank memory allocation method according to an embodiment of the invention. Again, as before, a functional SPU representation 500 includes four functional units 505a, 505b, 505c and 505d each performing the same execution sequence 510 of example instructions 515a, 515b, 515c, 515d, 515e and 515f. The intersection of instructions 515a-515f and functional units 505a-505d in a chart form represents the registers operated upon by the functional units 505a-505d. As before, at execution instruction 515b, a set of values X is loaded into registers 520a, 520b, 520c and 520d. At execution instruction 515e, a set of values Y is stored from registers 530a, 530b, 530c and 530d into shared memory 555.

Instead of storage via local stores (not shown) or thread data sets (not shown), the shared memory 555 is externally divided into memory banks 550a, 550b, 550c and 550d of predetermined sizes. The size of the banks represents a known number of memory addresses 540, and typically is allocated in segments of a natural size in the form of 2\hat{ }n (generally at least or greater than 16 bits), and in an embodiment in segments of 128 bits to conform to the 128 bit boundary 545 of the shared memory.

Thus, at execution of instruction 515b loading the set of values X into registers 520a-520d, value Xa 560a is loaded 525a from memory bank a 550a into register 520a, value Xb 560b is loaded 525b from memory bank b 550b into register 520b, value Xc 560c is loaded 525c from memory bank c 550c into register 520c, and value Xd 560d is loaded 525d from memory bank d 550d into register 520d. Similarly, at execution of instruction 515e storing the set of values Y from registers 530a-530d into shared memory, register 530a is stored 535a into memory bank a 550a as value Ya 570a, register 530b is stored 535b into memory bank b 550b as value Yb 570b, register 530c is stored 535c into memory bank c 550c as value Yc 570c, and register 530d is stored 535d into memory bank d 550d as value Yd 570d.

By providing pre-determined memory banks for each thread, conflicts between memory banks, as well as conflicts from the contiguous memory access method of FIG. 3 can be avoided. However, memory allocation is strictly limited to the size of the bank, such that memory allocation is less flexible. In addition, the method illustrated in FIG. 5 requires the rearrangement of data in order to make it compatible with other memory management methods shown in FIGS. 3 and 4.

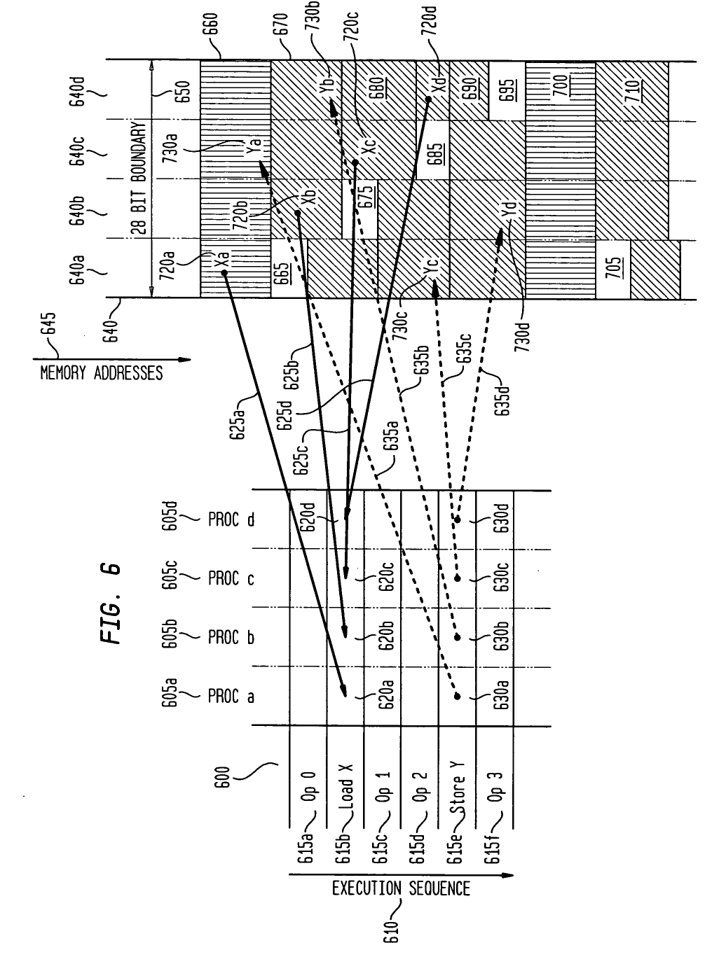

FIG. 6 is a functional diagram illustrating an embodiment of a staggered memory allocation according to another embodiment of the invention. Such memory allocation facilitates efficient single instruction multiple data (SIMD) as well as a multi-scalar execution of parallel executable instruction sequences. Multi-scalar operation, and a system and method for controlling such operation are described in commonly assigned, co-pending U.S. Provisional Application No. 60/564,673 filed Apr. 22, 2004. This application is hereby incorporated by reference herein.

Each of the methods described above with respect to FIGS. 3, 4 and 5 are subject to potential bank conflicts, or require data rearrangement when switching between SIMD and multi-scalar execution. However, a method of staggered memory allocation as shown herein in FIG. 6 permits switching between SIMD and multi-scalar execution modes without data rearrangement, and avoids bank/logical-store conflicts that might otherwise delay thread execution.

As before, a functional SPU representation 600 includes four functional units 605a, 605b, 605c and 605d each executing a respective thread PROC a, PROC b, PROC c and PROC d to perform the same execution sequence 610 of instructions 615a, 615b, 615c, 615d, 615e and 615f. The intersection of the six instructions 615a-615f and the four functional units 605a-605d in a chart form represents the registers operated upon by the six instructions 615a-615f. As before, at execution instruction 615b, a set of values Xa, Xb, Xc and Xd are loaded into registers 620a, 620b, 620c and 620d. At execution instruction 615e, a set of values Ya, Yb, Yc and Yd are stored from registers 630a, 630b, 630c and 630d into respective locations of the memory 640.

The memory 640 includes four regions or banks 640a, 640b, 640c and 640d, each 32 bits in width, thus allowing single instruction memory access on a 128 bit boundary 650. The functional view of memory 640 includes memory addresses 645 in a row and column form. For each functional unit 605a-605d, and respective thread PROC a, PROC b, PROC c and PROC d, a memory location is created based on a base address and offset. Thus, for the first functional unit 605a, a first memory location 660 is created with a zero offset starting with memory region 640a at an available memory row. For the second functional unit 605b, at an available different row of the memory a second memory location 670 is created with a vertical offset 665 of two rows of the memory plus one 32 bit memory block.

The memory location 670 takes into account the offset 665 and thus wraps around to the next memory row to ensure that all four memory regions, e.g., memory banks 640a-640d are used, but that the location of particular memory values (which are generally the same for similar memory banks as shown in FIG. 5 or for thread data sets as shown in FIG. 4) remain the same internally to each particular memory location but are staggered with respect to the shared memory 640. In this manner, additional vertically offset memory locations 680 and 690 are created to correspond to functional units 605c and 605d respectively, and each employs an offset block 675 and 685 respectively. Further blocks 700 and 710 and offsets 695 and 705 (although not used herein) are provided for clarity to show the memory allocation staggering technique used herein.

Thus, at execution instruction 615b, loading a set of values X from shared memory into the respective processor threads, a value Xa 720a is loaded 625a from memory location 660 associated with functional unit 605a into register 620a. Similarly, values Xb 720b, Xc 720c and Xd 720d are loaded 625b, 625c and 625d from memory locations 670, 680 and 690, respectively into registers 620b, 620c and 620d respectively. In this manner, bank conflicts, i.e. conflicts for accessing the memory regions are avoided, and memory staggering permits relatively easy transition from one memory mode to another.

In such manner, when data is needed for SIMD execution, data is loaded simultaneously from the four regions 640a-640d to all four of the registers 320a-320d from the vertically offset locations of the shared memory. On the other hand, when data is needed for multi-scalar processing, back-to-back sequential access is provided to load data to an individual register of a functional unit. For example, the data value Xb is loaded from offset location 720b to register 620b on a first access. On the next back-to-back sequential access thereafter, another data value, for example value Xa, can be loaded from location 720a to register 620b, the memory permitting such back-to-back sequential accesses because they lie in different regions (banks) of memory and at different vertical offset locations.

Similarly, upon execution of instruction 615e storing a set of values Y, register values 630a, 630b, 630c and 630d are respectively stored into respective memory regions 660, 670, 680 and 690 at respective locations Ya, Yb, Yc, and Yd.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method for executing instructions by a plurality n of functional units of a processor, said n functional units operable to execute instructions in a single instruction multiple data (SIMD) manner and to execute instructions in a multi-scalar manner, comprising:
loading data from a shared memory into one or more registers, each register holding data for execution by a particular functional unit of said plurality of functional units;
performing at least one operation selected from the group consisting of:
executing an instruction by said plurality n of functional units on data held in the registers belonging to all of said plurality n of functional units; and
executing one or more instructions by a number x, 0<x<n, of functional units on the data loaded in a corresponding number x of the registers belonging to said x functional units; and
thereafter storing second data held in respective ones of said registers to locations of the shared memory in respective regions of the shared memory, said locations further being vertically offset from each other.

2. A method as claimed in claim 1 wherein said locations are vertically offset by at least one row of the shared memory.

3. A method as claim 1 further comprising simultaneously loading data from said respective regions of the shared memory to all the registers of said functional units of said processor, said respective regions of said memory permitting simultaneous access to said vertically offset locations.

4. A method as claimed in claim 1 further comprising loading data back-to-back sequentially from individual locations of the shared memory to respective individual ones of the registers of said functional units of said processor, said respective regions of said memory permitting back-to-back sequential access to said locations in said respective regions of said memory.

5. A method for allocating a plurality of memory regions for holding data and instructions for execution by a plurality of functional units of a processor, comprising:
allocating respective ones of a plurality n of regions of a memory to respective ones of a plurality n of functional units of said processor, each functional unit having a register of a size of 2\hat{ }x bits;
storing data within a first memory region of said plurality of memory regions at locations vertically offset from the locations at which data is stored within a second memory region of said plurality of memory regions.

6. A method as claimed in claim 5 further comprising loading said stored data to registers of all of said n functional units of said processor simultaneously from ones of said vertically offset locations of said n regions of said memory.

7. A method as claimed in claim 5 wherein said vertically offset locations are offset by at least one row of said shared memory.

8. A method as claimed in claim 5 wherein said memory regions are respective banks of said shared memory.

9. A method as claimed in claim 8 wherein said vertically offset locations are determined by an offset in relation to a base address, said base address corresponding to a location of said memory locations relating to a first functional unit of said functional units.

10. A system for multi-threaded execution of a single set of instructions on multiple sets of data, comprising:
a system bus;
at least one processing unit on said system bus, each said processing unit including a processing unit bus, a direct memory access controller on said processing unit bus, a processor on said processing unit bus, a plurality of synergistic processing units on said processing unit bus, each said synergistic processing unit including a register, an instruction processor, and a plurality of functional units, each said functional unit including a local store, a floating point unit, and an integer unit;
a local input output channel on said system bus;
a network interface connected to said system bus;
a shared memory connected to said system bus, said shared memory divided by said functional units of said synergistic processing units of said processing units into a plurality of memory regions, wherein data of each of said functional units is stored to a location in a different one of said memory regions, said locations further being vertically offset from each other on basis of said functional units, each said memory region communicating with an associated said functional unit of a said synergistic processing unit of said processing unit via said local stores and said direct memory access controllers over said processing unit bus and said system bus.

11. A system as claimed in claim 10 wherein said locations are vertically offset by at least one row of the shared memory.

12. A system as claimed in claim 10 wherein said synergistic processing unit is further operable to simultaneously load data from respective regions of the shared memory to all the registers of said functional units of said processor, said respective regions of said memory permitting simultaneous access to said vertically offset locations.

13. A system as claimed in claim 10 wherein said synergistic processing unit is further operable to load data back-to-back sequentially from individual locations of the shared memory to respective individual ones of the registers of said functional units of said processor, said respective regions of said memory permitting back-to-back sequential access to said locations in said respective regions of said memory.
